(19) United States
(12) Patent Application Publication
(10) Pub. No.: US 2018/0129490 A1
(43) Pub. Date: May 10, 2018

(54) OBJECT ORDERING PRESERVATION DURING LTO LINK STAGE

(71) Applicant: Qualcomm Innovation Center, Inc., San Diego, CA (US)

(72) Inventors: Shankar Kalpathi Easwaran, Austin, TX (US); Sergei Larin, Austin, TX (US); Tobias Edler Von Koch, Austin, TX (US)

(21) Appl. No.: 15/708,809

(22) Filed: Sep. 19, 2017

Related U.S. Application Data
(60) Provisional application No. 62/419,761, filed on Nov. 9, 2016.

(51) Int. Cl. G06F 9/45; G06F 9/445

(52) U.S. Cl. CPC G06F 8/4441; G06F 8/54

(57) ABSTRACT

A method for enforcing an original order of global symbols during link-time optimization of software code in the presence of a linker script. The method may comprise scanning the original order of global and local symbols in an input file and then recording the original order as a map structure. The method may then include mapping the global symbols to original output sections and interpreting the map structure. The method may then comprise sorting the global and local symbols and emitting an executable wherein the original order of the global and local symbols is preserved.

### CLAIM OF PRIORITY UNDER 35 U.S.C. § 119

The present Application for Patent claims priority to Provisional Application No. 62/419,761 entitled “SYSTEM AND METHOD FOR LINK TIME OPTIMIZATION” filed Nov. 9, 2016, and assigned to the assignee hereof and hereby expressly incorporated by reference herein.

### FIELD OF THE DISCLOSURE

The present disclosure relates generally to compilers that compile high-level code to machine code, and more specifically, to link time optimization.

### BACKGROUND

In general, a compiler is a computer software program that transforms high-level computer programming code, such as source code written in a human-readable language (e.g. C, C++), into lower-level assembly or machine code (e.g., binary). Compilers utilize various optimization techniques in order to improve the performance of the resulting executable. In general, optimization allows a program to be executed more rapidly or utilize fewer resources. Link time optimization (LTO) is a powerful compilation technique typically utilized in general computing environments, such as desktop computers, that allows broadening of the optimization scope in programming languages that otherwise compile a program one file at a time. That is, the optimization scope can be broadened so that the compiler can compile and optimize more than one file at a time. LTO utilizes a computer program (i.e., a utility) known as a linker which links together multiple files of a source program, once optimized by the compiler, to a final executable comprising distinct sections of binary code.

A linker script is another utility used in conjunction with a linker, often in embedded application environments. It is used to express a fine degree of control over the final executable image—and namely, the particular sections thereof—produced during the compilation (and optimization) process.

In the past, the use of linker scripts with LTO had been virtually incompatible. However, recent technological developments have provided systems and methods for using LTO in the presence of a linker script. However, such use of a linker script leads at times to a need for additional utilities and functions to further optimize execution of the linked code.

### SUMMARY

An aspect of the present disclosure provides a method for enforcing an original order of global symbols during link-time optimization of software code in the presence of a linker script. The method may comprise scanning the original order of global and local symbols in an input file and then recording the original order as a map structure. The method may then include mapping the global symbols to original output sections and interpreting the map structure. The method may then comprise sorting the global and local symbols and emitting an executable wherein the original order of the global and local symbols is preserved.

Another aspect of the disclosure provides a computing device comprising a processor and a memory configured to execute a linker and a compiler, wherein the linker and compiler are configured to perform a method for enforcing an original order of global symbols during link-time optimization of software code in the presence of a linker script. The method may comprise scanning the original order of global and local symbols in an input file and then recording the original order as a map structure. The method may then include mapping the global symbols to original output sections and interpreting the map structure. The method may then comprise sorting the global and local symbols and emitting an executable wherein the original order of the global and local symbols is preserved.

Yet another aspect of the disclosure provides a non-transitory, computer-readable storage medium configured to perform a method for enforcing an original order of global symbols during link-time optimization of software code in the presence of a linker script. The method may comprise scanning the original order of global and local symbols in an input file and then recording the original order as a map structure. The method may then include mapping the global symbols to original output sections and interpreting the map structure. The method may then comprise sorting the global and local symbols and emitting an executable wherein the original order of the global and local symbols is preserved.

### BRIEF DESCRIPTION OF THE DRAWINGS

FIG. 1 shows a high-level view of an LTO tool flow in the presence of a linker script.

FIG. 2 shows the different types of compiled code produced by a compiler in a first compilation step of an LTO process.

FIG. 3 depicts how the output sections of an executable in conventional LTO might compare with output sections of an executable in the presence of a linker script.

FIG. 4 shows a components of the LTO tool flow of FIG. 1, with depictions of additional subcomponents of the linker, compiler, and application program interfaces.

FIG. 5 is a timing diagram of the LTO tool flows depicted in FIG. 4.

FIG. 6 is a logical block diagram depicting components that may implement an ordinal order of symbols according with the present disclosure.

FIG. 7 shows examples wherein input files and link command lines result in both incorrect and correct symbol orders in an executable layout.

FIG. 8 is a flowchart of a method of performing an embodiment of the present disclosure.

FIG. 9 is a hardware diagram of a computing device that may implement aspects of the present disclosure.

### DETAILED DESCRIPTION

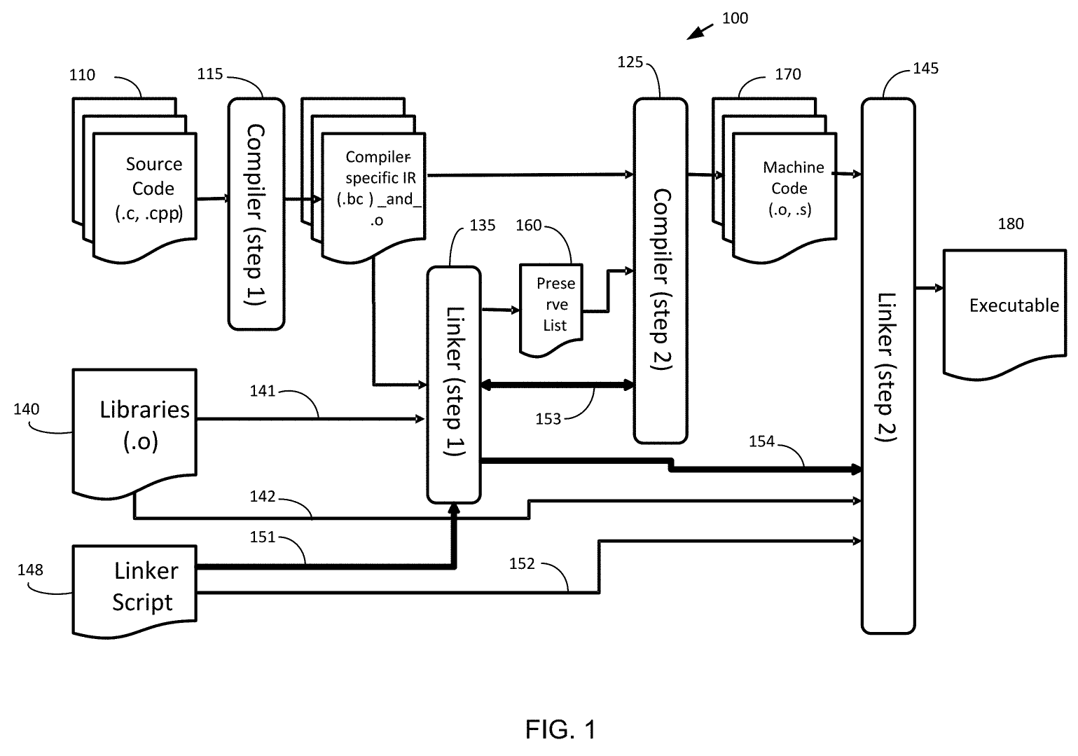

LTO is a highly desirable optimization methodology because it is powerful and works well in very demanding general purpose development environments. Until recently, LTO had not often been used in the presence of linker scripts because the two techniques had inherent conflicts that made them incompatible. However, new approaches described in co-pending and commonly owned U.S. patent application Ser. Nos. 15/273,527 and 15/273,511, which are incorporated herein by reference, allow for the use of LTO in the presence of a linker script. Aspects of the methods, interfaces, and solutions that enable the use of LTO in the presence of a linker script are described herein with reference to FIG. 1

FIG. 1 is a logical block diagram depicting several aspects of an exemplary embodiment. The diagram depicts a process 100 of compiling and linking received source code to an executable in an LTO build flow in the presence of a linker script. FIG. 1 is a logical diagram and should not be construed to be a hardware diagram. The logical blocks in FIG. 1 may be implemented in software, hardware, firmware, or a combination of hardware, software, and firmware. The process outlined in FIG. 1 may be implemented by a compiler and a linker that interact with each other and with versions of code at particular steps in the process. The compiler and linker may each be thought of as single software programs broken up into steps to show inputs, outputs, and the timing of communication between each program. For ease of reference, a single compiler is depicted as operating at Compiler (step 1) 115 and Compiler (step 2) 125 with Linker (step 1) 135 and Linker (step 2) 145. Throughout the disclosure, the compiler may be referred to interchangeably at its first and second steps as “first/second step of the compiler,” “first/second stage of the compilation,” “the compiler at step one/two,” or “the compiler at stage one/two.” The linker may be referred to with similar terminology and reference to the first or second steps or stages.

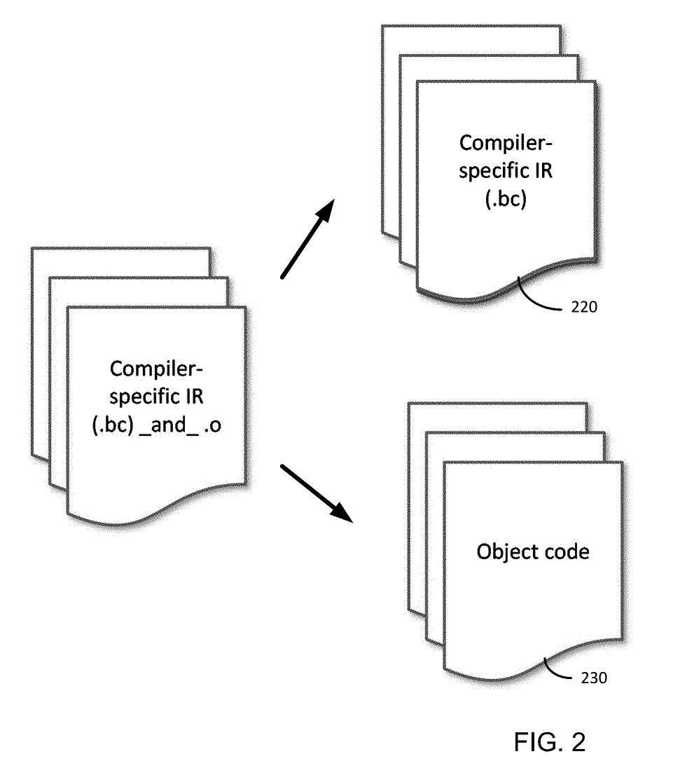

Compiler (step 1) 115 first receives source code 110 of a program. As shown, the source code 110 has example file extensions .c and .cpp, (indicating source code written in C or C++, respectively), but source code may be received in other languages, or may be in a human-readable assembly language. Compiler (step 1) 115 then compiles the source code 110 into two types of files, the first of which being compiler-specific and platform independent intermediate representations (IR, also referred to as internal representation), designated with a .bc (bit code) file extension, and the second of which being platform specific object code (designated with a .o file extension). Compiler (step 1) 115 performs optimizations that are possible at the level of local scope (i.e., one file or one library) and do not yet require information about the global scope (i.e., a whole program). Most optimizations may be performed later, at Compiler (step 2) 125. FIG. 2 shows how these two types of files compiled at Compiler (step 1) 115 are distinct, and turning now to a discussion of their differences will facilitate an understanding of the present disclosure. While discussing the subsequent figures, reference may still be made to the components in FIG. 1.

FIG. 1 also shows a linker script 148 in communication with Linker 135, 145 at interfaces 151 and 152, respectively. A linker script allows a user (i.e., a developer) to explicitly describe the memory layout of the executable image produced by the linker. This is a facility often used for embedded applications where users want to exert a fine degree of control in order to support techniques such as compression, tightly coupled memory (TCM) placement, and dynamic heap reclamation that are applied to some, but not all, or the input data and code (historically called “text”). The order of input files themselves (i.e., .c and .cpp files) can also affect the linking process, in addition to the linker script's impact on the linking process. The systems and methods of the present disclosure ensure that the output executable image is not divergent between LTO and non-LTO cases.

The steps that facilitate the linker script support are depicted as interfaces 151, 153, and 154, each of which are highlighted in bold lines. Each of these steps represent one or more interfaces, communication channels, and/or instructions that allow the linker script to be respected with the LTO tool flow. In particular, the linker script 148 may interact with Linker (step 1) 135 through interface 151, Linker (step 1) 135 may communicate with Compiler (step 2) 125 through interface 153, and Linker (step 1) 135 may communicate with Linker (step 2) 145 through interface 154. The interface 153 comprises an application program interface (API) and allows several pertinent aspects of the solution to be implemented, which will be described in detail through the disclosure. Linker (step 1) 135 generates a “preserve list” 160 to be used by Compiler (step 2) 125, which is also facilitated by the API 153. The final steps in the LTO flow 100 depicted are that Compiler (step 2) 125 compiles all the IR and object files into machine code 170, and Linker (step 2) 145 links compiled code from multiple sources to a final executable 180.

Each object file, whether it comes from source code that has been compiled in Compiler (step 1) 115, or from existing object libraries 140, includes global, local and common symbols that represent individual named memory objects. The term “symbols” referred to herein is a blanket term that encompasses both functions (i.e., a sequence of instructions in code that executes) and objects (i.e., a declared variable). After this first step of compilation 125, the rest of the compilation process is strongly dependent on what symbols are used and where they are used. Dependencies of symbols will be discussed throughout the disclosure, but in particular, each symbol is destined to a particular section of the executable. The system depicted allows Linker (step 1) 135 to parse (or read) the compiler-specific IR to be able to tell what symbols those particular IR files include, or whether the symbols are local, global, or common, so that the linker can assign output sections early on in the linking process.

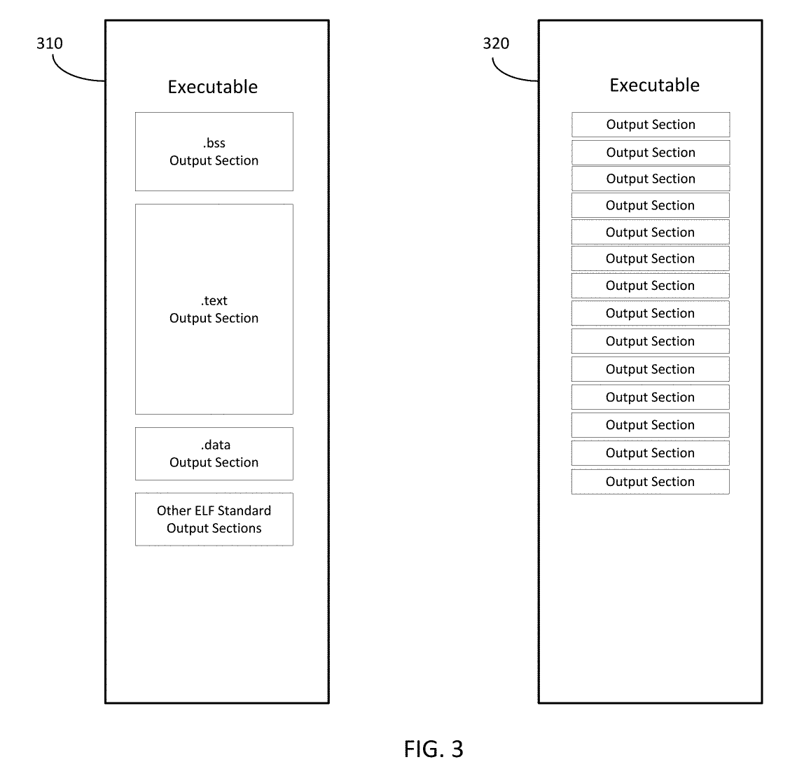

FIG. 3 conceptually illustrates an output format of an executable 310 in traditional LTO without a linker script and an output format of an executable 320 with a linker script, though the examples depicted are greatly simplified for the purposes of illustration. An executable 310 in traditional LTO may have a number of predefined sections, such as a .bss section for uninitialized objects, and a .text section for executable code, and a .data section for memory objects. One standard output format of an executable is known as ELF (Extensible and Linkable Format), and can be used here for illustration purposes on how a typical executable produced by a linker in traditional LTO, such as executable 310, may have around one or two dozen sections. An executable that is produced as the result of linking under direction of a custom linker script, such as executable 320, has sections that are specifically defined by the linker script. These sections likely have different attributes than a typical executable produced by linking in general. Although the linker script-produced executable 320 does not necessarily have to have more sections, in many implementations, the linker script-produced executable 320 will have more sections, sometimes numbering in the thousands. This is because, as will be described later, each function and object of a source code file may be placed in its own individual section as part of the present solution. Therefore, executable 320 is depicted as having many more individual output sections than executable 310.

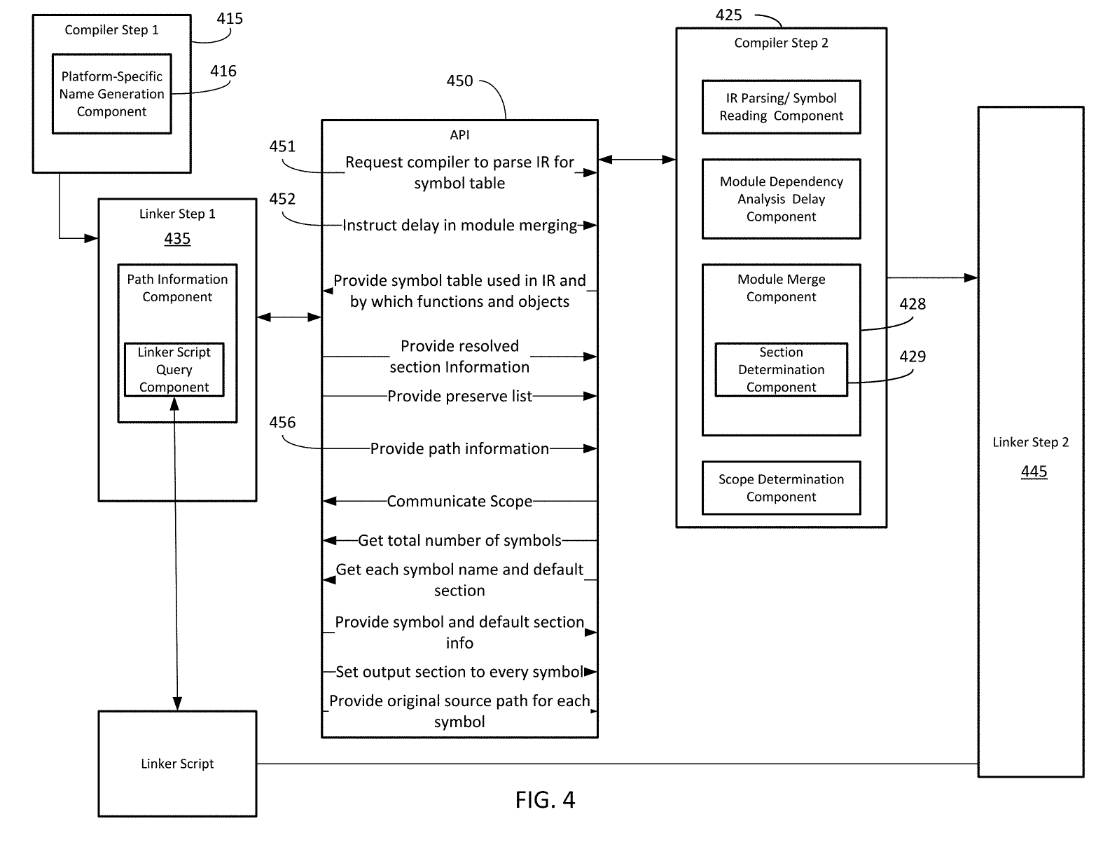

FIG. 4 is a logical block diagram showing several components of the LTO tool flow of FIG. 1 in greater detail. The components depicted in FIG. 4 are not intended to be a hardware diagram, but are intended to show logical steps and connections implemented in software and/or hardware. Certain components that are present in FIG. 1 are omitted from FIG. 4 for the sake of clarity. In one aspect of the disclosure, the solution changes the process of compiler IR code generation to include platform-specific name generation for each function and object destined for LTO. Compiler (step 1) 415 comprises a platform-specific name generation component 416. In existing compilation processes, certain flags are provided in source code (more particularly, in the makefile) for particular functions and objects. Certain types of flags, for example, indicate how a particular function should be optimized more for speed or another one more for size. Other types of flags include “−f-function-sections” flags for functions and “−f-data-sections” for objects. These flags allow the assignment of functions and objects to certain output sections. If there is no such flag, all functions will, for example, be placed in the output section “.txt.” However, if a function is flagged with −f-function-section, then the function will be placed in its own specific section, named “.txt.name of the function,” for example. The platform-specific name generation results in a particular function or section being named in this manner. The flagging of functions and objects is an existing capability, but it can be used for implementing aspects of the present disclosure. It is one way that each function and object will be put in its own individual section. A compiler itself can delete sections, but this feature of platform-specific name generation is helpful because the linker itself deals with sections, and has the ability to delete sections, but cannot delete functions or objects. As a result of flagging each function and object, each section now has its own name, and may be dealt with more easily by the linker as well as the compiler. Metadata is used (by the compiler) to store these flags and other information in association with each symbol. It is contemplated that other ways may be used to name individual sections without departing from the scope or the present disclosure.

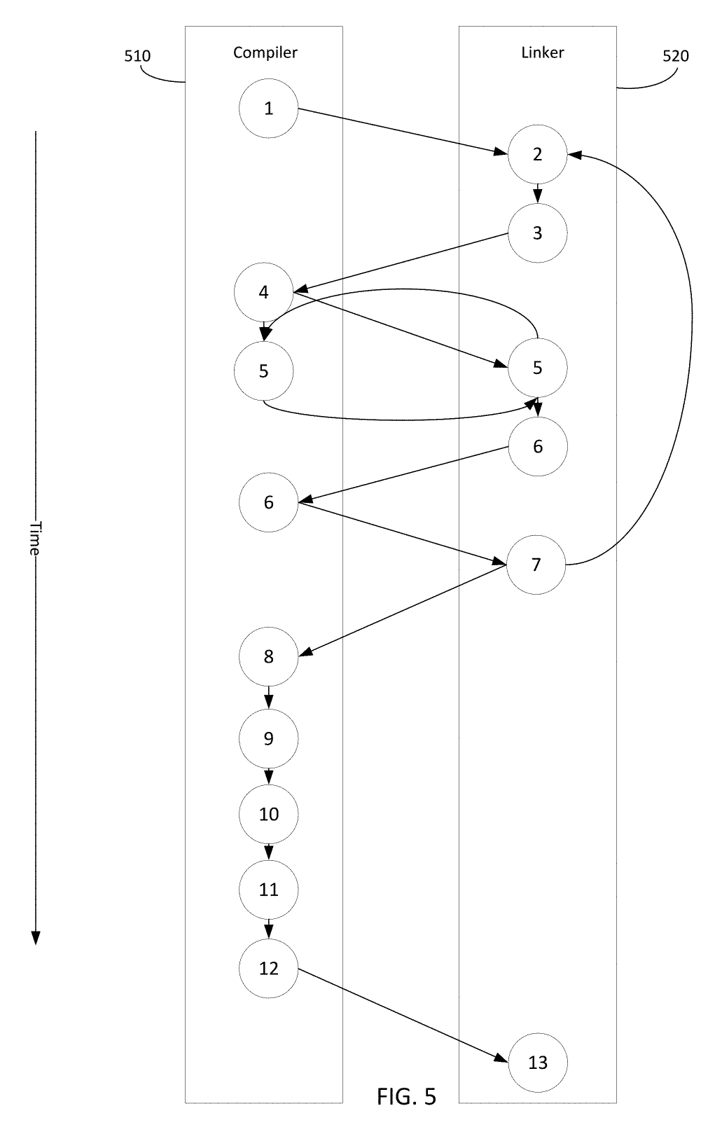

Referring still to FIG. 4, the diagram shows how features in the LTO tool flow facilitate LTO in the presence of a linker script. One aspect of the disclosure is that an API 450 facilitates communication between the linker at step one 435 and Compiler (step 2) 425. Within the API 450 are several process or method steps, depicted as flowing from either left to right (signifying a communication or request from the linker to compiler) or right to left (signifying a communication or request from compiler to linker). The steps are also depicted in a timing diagram in FIG. 5 to more clearly show the sequence of events between the linker and compiler as depicted here in FIG. 4. Each of these process or method steps may be implemented in an algorithm in the API 450. Though the process or method steps are depicted in a particular order from top to bottom, they are not necessarily implemented in the particular order, and may be implemented simultaneously or in an overlapping manner in actuality.

Depicted within Linker (step 1) 435 and Compiler (step 2) 425 are various logical block components for implementing aspects of the system. In particular, they implement many of the communications and requests depicted in the API 450, as well as other features of the solution. The blocks are logical and are not to be construed as a hardware diagram, and may be implemented by software alone, hardware alone, or a combination of hardware and software.

One aspect of the API 450 is that it allows Linker (step 1) 435 to request that the compiler parse its own IR in order to identify the symbols contained within the IR and def-use (definition and use) relationships between them at step 451. That is, code contained within IR may contain both definitions and uses, but until that IR is parsed, the compiler and linker cannot tell if there are any functions or sections that are not going to be used and could be eliminated. In another aspect, the system API 450 allows the compiler to delay module dependency analysis at step 452. Modules are how calls blocks of code that exist within a particular file are referred to in relation to a compiler and roughly correspond to source code files. During traditional LTO, the linker sends the compiler multiple code modules to be accumulated (or “merged”) into the single optimization scope. In traditional LTO, the sending of the multiple code modules to the compiler for merging is beneficial and allows for greater code optimization by the compiler. However, in LTO in the presence of a linker script, the compiler sends the linker parsed IR with symbol information and dependency information about the symbols with each module that is parsed. If dependency analysis were to be performed by the compiler incrementally as modules are received from the linker, the linker would receive dependency information back incrementally as well, which would be incomplete. In implementations of LTO in the presence of a linker script, the compiler provides the linker with IR symbol dependencies.

As previously mentioned, one of the tasks a compiler does during compilation in LTO (at Compiler (step 2) is to merge all of the modules together before sending them back to Linker (step 2). Because of the API 450 and the steps of communication facilitated therethrough, Compiler (step 2) 425 is able to gather all functions and objects that might be visible to the linker at the final link stage (at Linker (step two) 445) and log default output section information that is stored in the IR. This gathering of all functions and objects may be done on the level of each individual module so that the module-to-symbol relationship is not lost. Then, Compiler (step 2) 425 merges all modules into a single optimization scope via the module merge component 428. and internalizes symbols with respect to available output section information and the preserve list. This internalization produces different results from existing localization processes.

As a result of the additional communication between the linker and compiler via the APIs, compilation can commence with the use of the additional output section information. In FIG. 4, this is depicted as the section determination component 429 within the module merge component 428, to illustrate that the use of section information by the compiler takes place during the module merge process. Because the compiler now knows what output sections certain functions and objects will ultimately be placed, the compiler can use that information to both restrict and facilitate various compilation decisions. It is contemplated that, in general, that different output sections can be treated differently. When the compiler has this output section information, the compiler can be much more effective at reducing the size of compiler code without an impact on performance. Additionally, more input from a used may be solicited via a linker script to assign various properties to various output sections. These properties might include “hot or cold,” performance vs size tradeoff, or even a “firewall requirement that no control flow transfer is possible between certain output sections. Additional input from a user can also allow for improved security features.

At the end of the compilation process, the compiler materializes local variables and functions to their intended output sections, and leaves global and common objects to be placed by Linker (step 2) 445. Linker (step 2) 445 also conducts the final assignment of sections and a final step of garbage collection, resulting in the final executable image.

The overall optimization process of the present disclosure as described in relation to various components of the linker, compiler, and API in FIG. 4 may also be understood by describing the process in terms of timing. FIG. 5 shows a timing diagram with simple linear representations of a compiler 510 and linker 520, with steps 1-13 of the process shown taking place in the linker, compiler, or both in relation to time. The compiler 510 and linker 520 are not depicted as having two separate stages in the way that they are depicted in FIG. 4, but it is to be understood that the functionality described in relation to FIG. 5 is the same as that described in relation to FIG. 4. As such, it is also to be understood that the API (depicted in FIG. 4, but not depicted in FIG. 5) enables the communication between the compiler 510 and the linker 520.

Turning now to each of the steps in FIG. 5, at step 1, the compiler 510 receives a selection of source files (e.g., .c, .cpp, etc.). Based on the makefile of the source code, some of the source files are initially compiled to IR (.bc) and others to object code (.o). Then, according to the method of the present disclosure, for each symbol (i.e., function or object) that is destined to be compiled to IR, the compiler adds metadata containing the symbol's default section assignment.

Next, at step 2, linking begins in the linker 520. The linker 520 receives a selection of compiled files (both in IR and object code) as well as a linker script. For each symbol that is in object code, both their origin path and their output section is recorded, and their dependency information is updated. For each IR file, the origin path is also recorded, but because their output sections and dependencies cannot be read by the linker, the linker requests the compiler to parse the IR. However, before sending the IR and the request back to the compiler, the linker, at step 3, reads the IR file into memory.

Once the linker sends the IR and parsing request to the compiler (as depicted by the arrow between steps 3 and 4), an aspect of the present disclosure is that the compiler, at step 4, receives a memory buffer containing the content of the .bc file (the IR) and reads it as a compiler module. The compiler them parses the content of the module and records information about each symbol. Included in this recorded symbol information is the default section assignment that was initially recorded in the metadata for each symbol in step 1. Another aspect of the disclosure is that dependencies are recorded for each symbol that exists in the IR module. Then, the module is merged with any previously read IR modules. Once parsing is complete, the compiler informs the linker that it is complete, as represented by the arrow between steps 4 and 5. The requesting, parsing, recording, merging, and communicating back to the linker may be facilitated in whole or in part by the API between the compiler 510 and the linker 520.

Step 5 is depicted as taking place at both the compiler 510 and the linker 520. At step 5, the linker 520 actually receives the symbol information that has been parsed and recorded from the compiler 510. Step 6 is also depicted as occurring at both the linker 520 and compiler 510. At step 6, in the linker 520, the linker uses the default section information for all the symbols in IR that were received in step 5. Then, using the linker script, the linker 520 is able to assign output sections to the symbols that were in IR and then inform the compiler about that output section assignment (depicted at compiler 510 step 6). This step allows the fine control of output sections according to the linker script that would not have been possible if the linker 520 did not have the symbol information for IR files. Steps 2-6 may be repeated by the linker 520 and the compiler 510 until all files of the source code are processed.

Once all input files have been processed, and all symbols for both object code and IR have been accounted for, a full dependency graph between all the symbols is available, and the linker can generate a preserve list, which it does at step 7. Then, the linker 520 sends the preserve list to the compiler (as depicted by the arrow between steps 7 and 8). Then, at step 8, at the compiler 510, all global symbols that are not in the preserve list are localized to the current module. In prior approaches, symbols could be localized, but in the present disclosure, the preserve list has full symbol information and a dependency graph that allows more aggressive optimizations by the compiler 510.

Next, at step 9, the compiler 510 performs global optimization to the whole file scope. These optimizations are performed in view of the assigned output sections for each symbol. If, for some reason, a normal optimization that would be performed by the compiler 510 at this stage would violate the intended output section assignment as dictated by the linker script, the optimization is not performed, which is one advantage of the present disclosure. An additional advantage to the compiler 510 having all the output section assignments at this stage is that additional optimizations become available because of the output section information.

Next, at step 10, machine specific code generation is performed. During this step, the compiler assigns every symbol to a specific section, as required by ELF standards. As a result of the linker script output section assignment, all local symbols are assigned to their final output sections. All global symbols, however, are assigned to their default sections, as also required by ELF standards. Then, at step 11, the original symbol scope is restored. Previously localized symbols and any global symbols that were not eliminated during optimization are restored back to global scope. At step 12, one or more object files are generated by the compiler 510. These object files are then passed to the linker, as represented by the arrow between steps 12 and 13. At step 13, the final linking starts and results in the final executable image being created.

In the linker script with LTO tool flow described herein, the use of resolved output section information allows the linker script to be used during both classical and IPO (Inter Procedural Optimizations). This resolved section information allows additional IPO optimizations that are not possible without it.

Aspects of the present disclosure relate to the relative ordering of global symbols within an output section of an executable. Due to the nature of the previously described system of LTO in the presence of a linker script, both LTO files and non-LTO files could be mixed during compilation. When this happens, the linker loses the ability to maintain an implied “link command order,” which is also known as an “ordinal” order of global symbols within an output section. This is because the linker typically processes multiple non-LTO sections plus one combined LTO section sequentially, resulting in symbol reordering. If the original ordinal order is lost, the new, resulting order might create a number of problems. An incorrect order might potentially violate: 1) implicit assumptions by the user, 2) dependent library usage (dependency search order), and 3) determinism of the produced image. For example, if code has multiple weak definitions, the one encountered first by the compiler is the one used. The use of this one definition might mean different behavior between LTO and non-LTO code. A similar problem can occur if code contains duplicate library functions. Without a way to maintain the ordinal order of global symbols, the final executable image might have correctness and performance issues.

One example of a correctness issue is that can arise as a result of losing the ordinal order of symbols is that a developer of a linker script who relies on an ordinal order for functionality of the final executable may experience an error. For example, if the linker searches from left to right for dependencies, it is possible to generate a different version of the code if there are multiple objects with the same name. Then, based on the order in which the linker visited those ordinals (the symbols), different code can be generated. In some cases, the code can be functionally equivalent and just vary slightly in size, for instance due to different padding requirements. In other words, the code may be non-deterministic. A simple change in the size of objects can result in an executable with varying characteristics. Because developers often expect the compilations of their source code to be deterministic (i.e., identical each time), variations due to the loss of ordinal ordering can be problematic. Even small variations can affect post-processing of the code that some developers wish to implement. Additionally, if determinism is impacted, unforeseen outcomes of test coverage are likely.

To address the possibility of incorrect ordering of global symbols, aspects of the present disclosure provide enforcement mechanisms to guarantee ordinal sorting in the original order in the presence of LTO. In current implementation, LTO disturbs the existing linker command line In other words, LTO disturbs the order in which symbols appear to the linker. LTO effectively bundles selected object files—the ones in IR—and presents them to the linker in a single object. However, if the linker goes by that order (that of a single object), then the original order is lost. Another issue is that LTO can also introduce new symbols which do not have original path association information. This can result in these new symbols being placed in a random order that also messes up the ordinal order of the symbols.

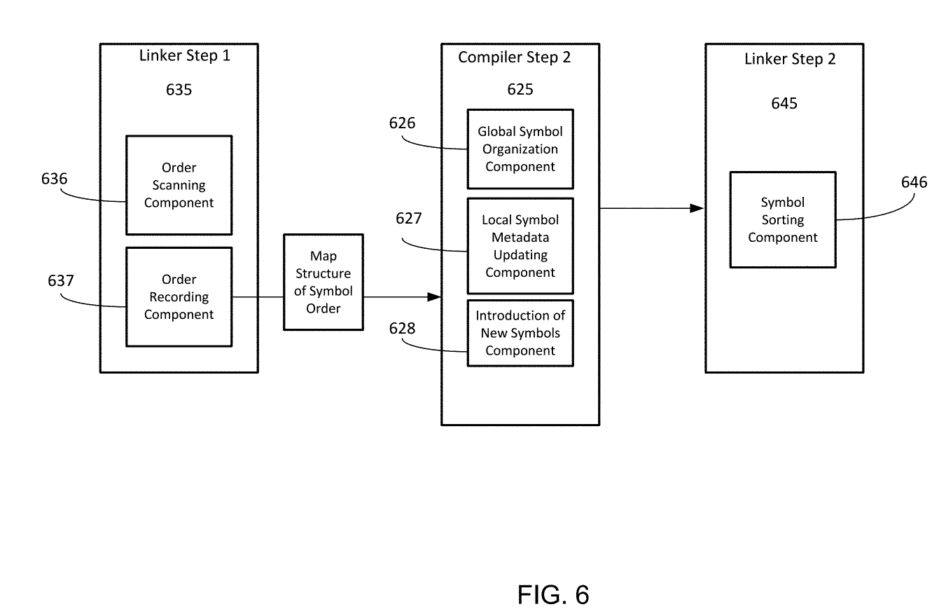

The method of the present disclosure may be referred to herein as a “method for enforcing ordinal ordering of symbols,” or simply “enforcing ordinal ordering, ” which has the objective of matching a final object order to that in non-LTO compilation. The method for enforcing ordinal ordering of symbols may be understood with reference to FIG. 6. FIG. 6 is a diagram illustrating portions of the linker script and LTO tool flows illustrated in FIGS. 1 and 4, omitting certain aspects previously described for clarity in illustrating the aspects presently described. As shown, in linker step 1 635, the original order is scanned via an Order Scanning Component 636. This scanning occurs prior to the merging of all IR files (as described in FIG. 4, at compiler step 2, module merge component 428). This order scanning component 636 reads the ordinal order of the symbols as listed in the root file. Then, still at linker step 1 635, the order is recorded at an Order Recording Component 637 as a map structure for all present global and local symbols. The map structure of the symbol order is sent from the linker step 1 635 to the compiler step 2 625.

Then, at the compiler step 2 the global symbols are mapped to their original output sections by a global symbol organization component 626. Here, the linker can consult the map that it recorded at linker step 1 635 and treat the global symbols as though they came from that input file. In other words, the map can tell the linker what input files the global symbols came from, and can treat the global symbols accordingly. Additionally, the local symbols, which have the relevant operating system path information already (as shown in step 456, FIG. 4) have their metadata updated by a local symbol metadata updating component 627 (at the compiler step 2 625) to point to the original input file. As a result, both the global symbols and local symbols are placed in the correct output sections according to their original input files. As previously discussed, the LTO itself introduces new symbols. Such global and local symbols, shown at the introduction of new symbols component 628, when introduced by the compiler step 2 625, are not initially sorted, but are rather left in the path produced by the LTO. The output section itself is set properly, but that alone is not always enough to ensure correct linking. A correct order of appearance of the symbols is also important. Prior to the emission of the executable, a sort step is performed at the linker step 2 645 to guarantee the original ordinal order of global symbols and to place the newly introduced local symbols correctly. This is done by a symbol sorting component 646.

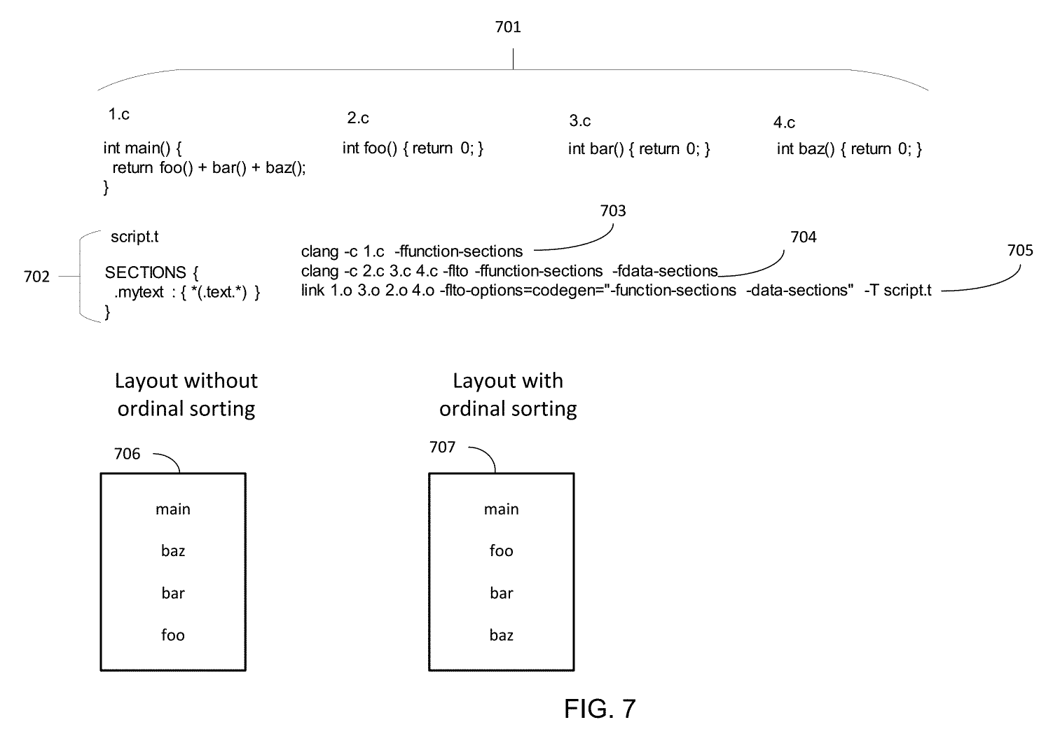

An simple example showing the relationship of global symbols in their input files and the possible outcomes of incorrect and correct ordinal ordering is illustrated in FIG. 7. As shown, input files 1.c, 2.c, 3.c, and 4.c are shown at the top of FIG. 7 at 701. Each of the files contain four different functions—“main,” “foo,” “bar,” and “baz”—which in this case are global objects. If all the objects had been in just one input file and compiled by a complier, the compiler would be able to see that the .c code of the input files clearly read that function foo returns 0, bar returns 0, and baz returns 0, so that the result of the function main (in file 1.c) is actually 0. However, as previously discussed, (see, e.g., FIG. 2) input files in LTO are not all compiled the same way; for example, when all symbols are in one file, there is one order, and one optimization level. When each symbol has its own file, there is another order, and no optimization. LTO allows optimization, but messes up the order of the symbols. The present solution allows for LTO optimization while preserving the order of the symbols.

Below the input files 1.c, 2.c, 3.c, and 4.c are command lines 702 of the linker script. The first command line 703, “clang -c 1.c-ffunction-sections” instructs the compilation of an object file written in object format. The second command line 704, however, “clang -c 2.c 3.c 4.c -flto” instructs that those files will be compiled into IR, and the contents of the resulting 2.o, 3.o, and 4.o files will be further compiled and finalized at link time.

The final link command line 705, which instructs “link 1.o 3.o.2.o 4.o,” is written that way because the way the order of files on the link command affects the order of symbols in the final ELF output section as well as the possible exact choice of symbol content. Therefore, files 3.o, 2.o, and 4.o are grouped together (i.e., merged for optimization) in this command line because they are in IR. As previously discussed, IR input files are all merged together for optimization at compiler step 2, so by the time they are ready for linking at the linker step 2, they may be out of their original ordinal order; in this case, they are in the order 3.o, 2.o, 4.o. These three merged files would be searched by the linker after 1.o, because 1.o was in initially in object code and never compiled into IR. However, this command line orders the global objects within original files 1.c, 2.c, 3.c, 4.c to be linked in the order of 1.o, 3.o, 2.o, 4.o.

The merging and compilation of IR files can result in the objects within those files being linked out of order in comparison to their original ordinal order. In the example shown, the “layout without ordinal sorting 706,” the linker reads the first expected object correctly, which is main, but the remaining objects from the IR files are in a random (and incorrect) order. They are linked in the order “baz, bar, foo.” Going back the original files above, in 1.c, the root is main, based on the tree. The order specified in main is foo, then bar, then baz. This is the order in which a user would expect the executable to list the global symbols. The method for enforcing the order of global symbols therefore ensures correctness and performance of the executable when a linker script is used with LTO. In the present example of FIG. 7, the correct order is shown as “layout with ordinal sorting” 707, in which the layout is in the correct order of “main, foo, bar, baz.”

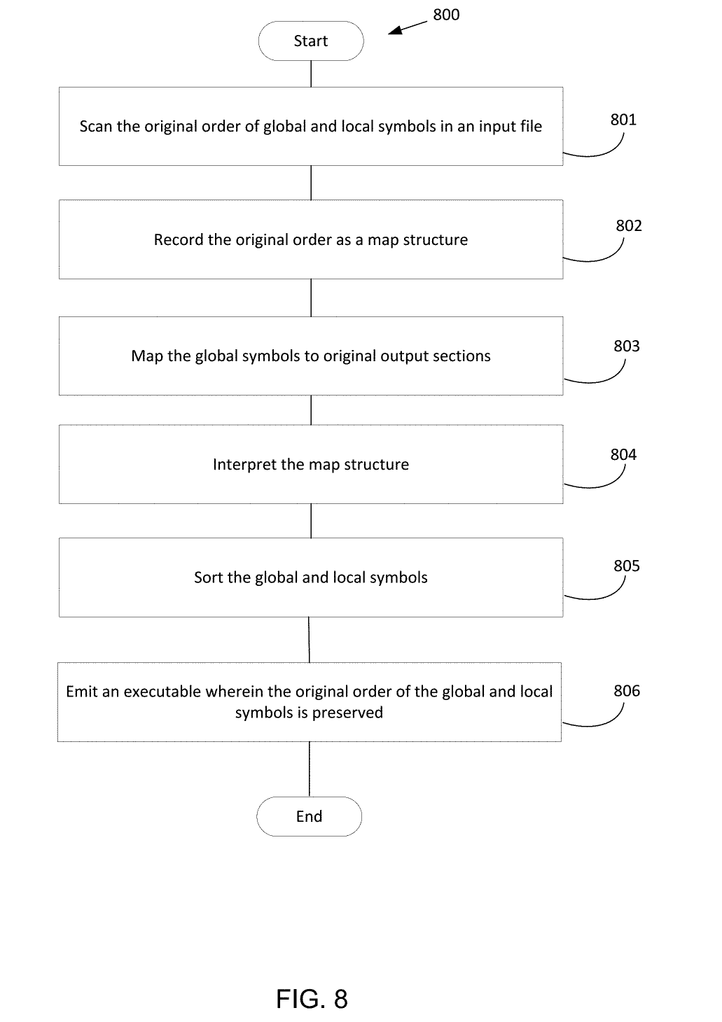

FIG. 8 is a flowchart which may be traversed to implement a method 700 of code optimization. The method may first include, at block 801, scanning the original order of global and local symbols in an input file. Then, at block 802, the method may comprise recording the original order as a map structure. At block 803, the method may include mapping the global symbols to original output sections. At block 804, the method may comprise interpreting the map structure as if received from the input file. The method may further comprise, at block 805, sorting the global and local symbols, and at block 806, emitting an executable wherein the original order of the global and local symbols is preserved.

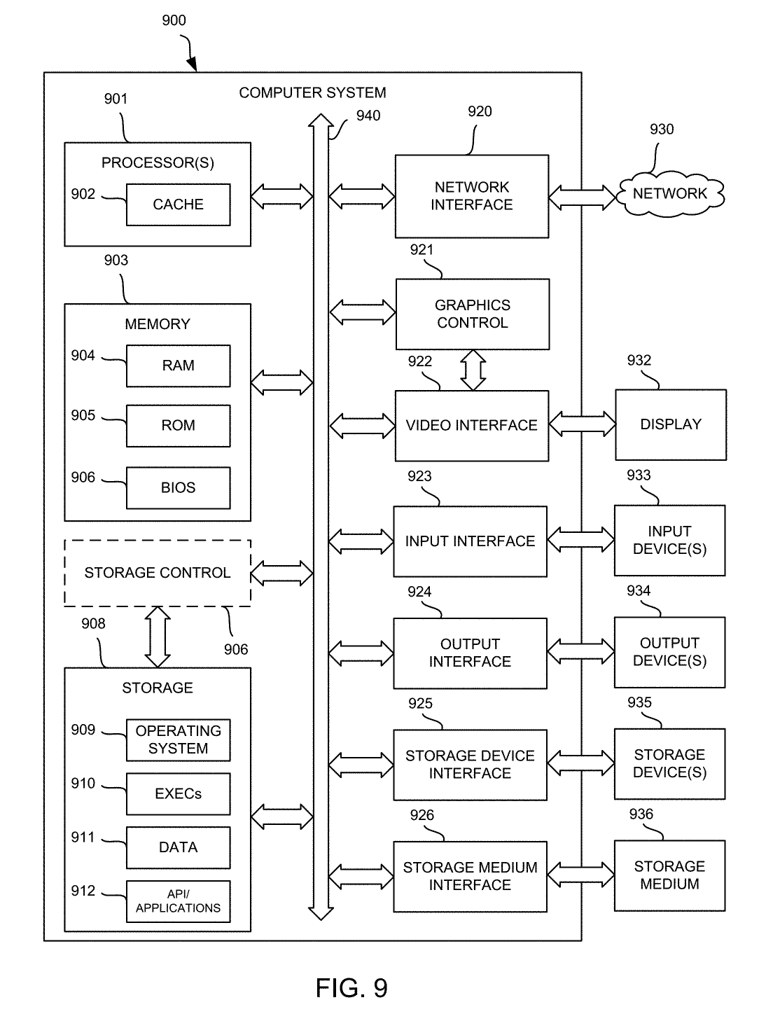

Referring next to FIG. 9, it is a block diagram depicting an exemplary machine that includes a computer system 900 within which a set of instructions can execute for causing a device to perform or execute any one or more of the aspects and/or methodologies for static code scheduling of the present disclosure. The components in FIG. 4 are examples only and do not limit the scope of use or functionality of any hardware, software, embedded logic component, or a combination of two or more such components implementing particular embodiments.

Computer system 900 may include a processor 901, a memory 903, and a storage 908 that communicate with each other, and with other components, via a bus 940. The bus 940 may also link a display 932, one or more input devices 933 (which may, for example, include a keypad, a keyboard, a mouse, a stylus, etc.), one or more output devices 934, one or more storage devices 935, and various tangible storage media 936. All of these elements may interface directly or via one or more interfaces or adaptors to the bus 940. For instance, the various tangible storage media 936 can interface with the bus 940 via storage medium interface 926. Computer system 900 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 901 (or central processing unit(s) (CPU(s))) optionally contains a cache memory unit 902 for temporary local storage of instructions, data, or computer addresses. Processor(s) 901 are configured to assist in execution of computer readable instructions. Computer system 900 may provide functionality for the components depicted in FIG. 1 as a result of the processor(s) 901 executing non-transitory, processor-executable instructions embodied in one or more tangible computer-readable storage media, such as memory 903, storage 908, storage devices 935, and/or storage medium 936. The computer-readable media may store software that implements particular embodiments, and processor(s) 901 may execute the software. Memory 903 may read the software from one or more other computer-readable media (such as mass storage device(s) 935, 936) or from one or more other sources through a suitable interface, such as network interface 920. The software may cause processor(s) 901 to carry out one or more processes or one or more steps of one or more processes described or illustrated herein. Carrying out such processes or steps may include defining data structures stored in memory 903 and modifying the data structures as directed by the software.

The memory 903 may include various components (e.g., machine readable media) including, but not limited to, a random access memory component (e.g., RAM 904) (e.g., a static RAM “SRAM”, a dynamic RAM “DRAM, etc.), a read-only component (e.g., ROM 905), and any combinations thereof. ROM 905 may act to communicate data and instructions unidirectionally to processor(s) 901, and RAM 904 may act to communicate data and instructions bidirectionally with processor(s) 901. ROM 905 and RAM 904 may include any suitable tangible computer-readable media described below. In one example, a basic input/output system 906 (BIOS), including basic routines that help to transfer information between elements within computer system 900, such as during start-up, may be stored in the memory 903.

Fixed storage 908 is connected bidirectionally to processor(s) 901, optionally through storage control unit 907. Fixed storage 908 provides additional data storage capacity and may also include any suitable tangible computer-readable media described herein. Storage 908 may be used to store operating system 909, EXECs 910 (executables), data 911, API applications 912 (application programs), and the like. Often, although not always, storage 908 is a secondary storage medium (such as a hard disk) that is slower than primary storage (e.g., memory 903). Storage 908 can also include an optical disk drive, a solid-state memory device (e.g., flash-based systems), or a combination of any of the above. Information in storage 908 may, in appropriate cases, be incorporated as virtual memory in memory 903.

In one example, storage device(s) 935 may be removably interfaced with computer system 900 (e.g., via an external port connector (not shown)) via a storage device interface 925. Particularly, storage device(s) 935 and an associated machine-readable medium may provide nonvolatile and/or volatile storage of machine-readable instructions, data structures, program modules, and/or other data for the computer system 900. In one example, software may reside, completely or partially, within a machine-readable medium on storage device(s) 935. In another example, software may reside, completely or partially, within processor(s) 901.

Bus 940 connects a wide variety of subsystems. Herein, reference to a bus may encompass one or more digital signal lines serving a common function, where appropriate. Bus 940 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 900 may also include an input device 933. In one example, a user of computer system 900 may enter commands and/or other information into computer system 900 via input device(s) 933. Examples of an input device(s) 933 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 933 may be interfaced to bus 940 via any of a variety of input interfaces 923 (e.g., input interface 923) including, but not limited to, serial, parallel, game port, USB, FIREWIRE, THUNDERBOLT, or any combination of the above.

In particular embodiments, when computer system 900 is connected to network 930, computer system 900 may communicate with other devices, specifically mobile devices and enterprise systems, connected to network 930. Communications to and from computer system 900 may be sent through network interface 920. For example, network interface 920 may receive incoming communications (such as requests or responses from other devices) in the form of one or more packets (such as Internet Protocol (IP) packets) from network 930, and computer system 900 may store the incoming communications in memory 903 for processing. Computer system 900 may similarly store outgoing communications (such as requests or responses to other devices) in the form of one or more packets in memory 903 and communicated to network 930 from network interface 920. Processor(s) 901 may access these communication packets stored in memory 903 for processing.

Examples of the network interface 920 include, but are not limited to, a network interface card, a modem, and any combination thereof. Examples of a network 930 or network segment 930 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 930, may employ a wired and/or a wireless mode of communication. In general, any network topology may be used.

Information and data can be displayed through a display 932. Examples of a display 932 include, but are not limited to, a liquid crystal display (LCD), an organic liquid crystal display (OLED), a cathode ray tube (CRT), a plasma display, and any combinations thereof. The display 932 can interface to the processor(s) 901, memory 903, and fixed storage 908, as well as other devices, such as input device(s) 933, via the bus 940. The display 932 is linked to the bus 940 via a video interface 922, and transport of data between the display 932 and the bus 940 can be controlled via the graphics control 921.

In addition to a display 932, computer system 900 may include one or more other peripheral output devices 934 including, but not limited to, an audio speaker, a printer, and any combinations thereof. Such peripheral output devices may be connected to the bus 940 via an output interface 924. Examples of an output interface 924 include, but are not limited to, a serial port, a parallel connection, a USB port, a FIREWIRE port, a THUNDERBOLT port, and any combinations thereof.

In addition or as an alternative, computer system 900 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for enforcing an original order of global symbols during link-time optimization of software code in the presence of a linker script, the method comprising:
scanning the original order of global and local symbols in an input file;
recording the original order as a map structure;
mapping the global symbols to original output sections;
interpreting the map structure;
sorting the global and local symbols; and
emitting an executable wherein the original order of the global and local symbols is preserved.

2. The method of claim 1, further comprising:
updating metadata of the local symbols to point to the input file.

3. The method of claim 1, further comprising:
introducing new symbols during link-time optimization; and
sorting the new symbols.

4. The method of claim 1, wherein the original order is recorded for a plurality of input files, a portion of the input files being compiled into object code and the another portion of the input files being compiled into intermediate representations during the link-time optimization.

5. The method of claim 1, wherein the scanning and recording takes place during a first step of a linker.

6. The method of claim 1, wherein the sorting takes place during a second step of a linker.

7. The method of claim 1, further comprising sending the map structure from a linker to a compiler.

8. A computing device comprising a processor and a memory configured to execute:
a linker; and
a compiler,
wherein the linker and compiler are configured to perform a method for enforcing an original order of global symbols during link-time optimization of software code in the presence of a linker script, the method comprising:
scanning the original order of global and local symbols in an input file;
recording the original order as a map structure;
mapping the global symbols to original output sections;
interpret the map structure;
sorting the global and local symbols; and
emitting an executable wherein the original order of the global and local symbols is preserved.

9. The computing device of claim 8, wherein the method further comprises:
updating metadata of the local symbols to point to the input file.

10. The computing device of claim 8, wherein the method further comprises:
introducing new symbols during link-time optimization; and
sorting the new symbols.

11. The computing device of claim 8, wherein the original order is recorded for a plurality of input files, a portion of the input files being compiled into object code and the another portion of the input files being compiled into intermediate representations during the link-time optimization.

12. The computing device of claim 8, wherein the scanning and recording takes place during a first step of the linker.

13. The computing device of claim 8, wherein the sorting takes place during a second step of the linker.

14. The computing device of claim 8, wherein the method further comprises sending the map structure from the linker to the compiler.

15. A non-transitory, tangible computer readable storage medium, encoded with processor readable instructions to perform a method for enforcing an original order of global symbols during link-time optimization of software code in the presence of a linker script, the method comprising:
scanning the original order of global and local symbols in an input file;
recording the original order as a map structure;
mapping the global symbols to original output sections;
interpreting the map structure;
sorting the global and local symbols; and
emitting an executable wherein the original order of the global and local symbols is preserved.

16. The non-transitory, tangible computer readable storage medium of claim 15, wherein the method further comprises:
updating metadata of the local symbols to point to the input file.

17. The non-transitory, tangible computer readable storage medium of claim 15, wherein the method further comprises:
introducing new symbols during link-time optimization; and
sorting the new symbols.

18. The non-transitory, tangible computer readable storage medium of claim 15, wherein the original order is recorded for a plurality of input files, a portion of the input files being compiled into object code and the another portion of the input files being compiled into intermediate representations during the link-time optimization.

19. The non-transitory, tangible computer readable storage medium of claim 15, wherein the scanning and recording takes place during a first step of a linker.

20. The non-transitory, tangible computer readable storage medium of claim 15, wherein the sorting takes place during a second step of a linker.
